(19) United States
(12) Patent Application Publication
(10) Pub. No.: US 2024/0327616 A1
(43) Pub. Date: Oct. 3, 2024

(54) METHOD FOR PREPARING ENGINEERED CRUMB RUBBER COMPOSITION FOR USE IN ASPHALT BINDER AND PAVING MIX APPLICATIONS

(71) Applicant: Asphalt Plus, LLC, Barrington, IL (US)

(72) Inventors: James Stepp, Springfield, IL (US); Redmond Clark, Barrington, IL (US)

(21) Appl. No.: 18/738,891

(22) Filed: Jun. 10, 2024

Related U.S. Application Data
(63) Continuation-in-part of application No. 16/283,305, filed on Feb. 22, 2019.
(60) Provisional application No. 62/633,988, filed on Feb. 22, 2018.

(51) Int. Cl. C08K 11/00; C08L 95/00

(52) U.S. Cl. CPC C08K 11/005; C08L 95/00

(57) ABSTRACT

A method for producing an engineered crumb rubber asphalt additive may comprise the steps of adding a non-elastomeric liquid to a plurality of structural particles and mixing the non-elastomeric liquid and the plurality of structural particles for a short period of time so that the non-elastomeric liquid coats a least a portion of the surface of the plurality of the structural particles. The structural particles may be crumb rubber particles.

### CROSS-REFERENCE TO OTHER APPLICATIONS

The present application is a continuation-in-part of U.S. patent application Ser. No. 16/283,305, filed Feb. 22, 2019, which claims the benefit of U.S. Provisional Patent Application No. 62/633,988, filed Feb. 22, 2018, the entire contents of each of which are incorporated herein by reference.

### TECHNICAL FIELD

The present technology relates to an engineered crumb rubber (ECR) asphalt additive that can be combined with gravel, sand, and hot asphalt binder in a dry mix or plant mix method to form an engineered crumb rubber modified asphalt product.

These and other objects, advantages and novel features of the present invention, as well as details of an illustrative embodiment thereof, will be more fully understood from the following description and the drawing.

### BACKGROUND

### Sources of Asphalt Pavement Failure

Asphalt pavements are produced from a compacted and hardened asphalt mix. The mix is composed of coarse and fine aggregates (including gravel, stone, and sand), as well as a heated liquid asphalt binder, which is the cement that holds the aggregates together. At normal ambient temperatures, the binder is a rigid solid, but it begins to liquefy at temperatures in excess of about 200° F. A hot mix of binder and aggregate is prepared before it is conveyed to a construction site. At the construction site, the hot mix is laid and then compacted before it cools. During cooling, the asphalt hardens. The resulting surface is durable and capable of supporting heavy vehicles and large traffic volumes for extended periods of time.

Asphalt pavements can fail in several ways, including: (1) permanent deformation at higher temperatures when a load is applied (rutting), (2) fatigue cracking, (3) extreme temperatures (thermal cracking), (4) cracking in response to loads applied and released when heavy vehicles pass across a paved surface (reflective cracking), and (5) moisture susceptibility. When a paved asphalt surface begins to rut or crack, water and salt can enter the pavement materials, accelerating the progressive failure of the pavement.

Rutting results from the accumulation of small amounts of unrecoverable strain as a result of repeated loads applied to the pavement. Rutting can occur for many reasons, including problems with the subgrade, problems with the base course, and problems with the asphalt mix design.

Fatigue cracking typically occurs when the pavement has been stressed to the limit of its fatigue life by the repetitive loads from moving and standing vehicles, especially loaded trucks. Pavement fatigue resistance is influenced by pavement design, pavement thickness, pavement quality, and road drainage design.

Low-temperature cracking of asphalt pavements occurs when an asphalt pavement contracts during a cold period, creating a strain in the pavement that causes regular transverse cracking. Binder characteristics related to binder softness at low temperatures is a very common cause of this problem.

Beyond thermal cracking, environmental moisture and temperature can also impact pavement performance through a loss in pavement strength, a weakening of the bond between asphalt binder and aggregate, and initiation of freeze-thaw expansion/contraction of the pavement.

When asphalt pavements are designed, manufactured and placed, the design-build process is focused on the road environment and the type/intensity of traffic expected on the road. The design goal is to produce a road surface that will perform with the longest life-span as economically as possible. In industry parlance, the road design will have the lowest life-cycle cost. This means that the road and pavement design must be effective in resisting the various rutting and cracking processes present during road use.

### Asphalt Binder and Mix Design

There are a number of different asphalt mix designs used by the paving industry. Mix design options include modifying the types and size distributions of aggregate used in the mix, the types of binders used in the mix, chemical additives used to enhance specific performance characteristics of the mix and varying the binder content used in the mix design. Some asphalt pavements are designed to be especially resistant to rutting and cracking, and those designs are typically used in areas of very heavy traffic, especially in areas of heavy truck traffic. In those designs, special aggregates, binders and chemical additives are combined to produce a “modified asphalt” pavement.

Generally speaking, in order to be durable and long-lasting as a road surface, most asphalt binders must be chemically altered. The asphalt industry has developed a wide array of additives to the asphalt binder and to the asphalt mix that can address specific pavement performance characteristics. For example, liquid asphalt binders can be chemically modified by the addition of un-vulcanized synthetic and natural rubber polymers. Those rubber products are blended into the asphalt binder at higher temperatures, causing the un-vulcanized rubbers to melt and disperse throughout the liquid asphalt binder, making the binder both stiffer (rut-resistant) and more flexible (crack-resistant). These additions produce a Polymer Modified Asphalt (PMA) binder that is commonly used in a wide range of high-stress environments.

### Crumb Rubber Modified Asphalt Pavements

Liquid binders can also be modified by the addition of vulcanized crumb rubber to the liquid binder, followed by a period of “cooking” or “digestion” of the rubber at relatively high temperatures (typically 350° F. to 400° F.). At those temperatures, the vulcanized crumb rubber cannot melt, oxidize or de-vulcanize, so the crumb remains intact. There are no material chemical interactions between the crumb rubber and the liquid binder. The crumb rubber does interact with the binder in a physical/mechanical sense. The surface pores of the rubber absorb or draw up some of the lighter, less viscous ends of the binder (Maltenes). This causes the rubber particles to both soften and swell, and the swollen rubber crumb increases the viscosity (stiffness or rutting resistance) and flexibility of the asphalt binder. More importantly, the addition of large numbers of crumb rubber particles (often more than twenty million crumbs in a ton of asphalt mix when the mean crumb rubber particle size is less than one fiftieth of an inch or 0.5 mm) will act to serve as crack pinning agents, further slowing crack propagation in compacted pavements. Like polymer modification, the addition of rubber to the binder increases the binder resistance to both rutting and cracking. Unlike PMA, the addition of crumb rubber to the binder does not result in a blended liquid. Although these are distinctly different modification processes with differing levels and types of rubber addition, extensive field work with crumb rubber modified binders by the states of AZ, FL, GA, TX and CA suggests that properly manufactured and placed asphalt mixes manufactured with Polymer-Modified Asphalt or recycled vulcanized crumb rubber (waste tire rubber) behave similarly in extending pavement life.

### Crumb Rubber Modified Binder Issues and Benefits

The use of crumb rubber (usually recycled tire rubber) into asphalt is not free of problems. In practice, crumb rubber is added to asphalt binders either at the oil terminal where asphalt binder is stored and distributed or at the asphalt mix production facility. Those blended crumb rubber/binder products using recycled crumb rubber are called “terminal blend” asphalt or “wet process” asphalt respectively. Crumb rubber is denser than heated asphalt binder, so when crumb rubber and heated asphalt binder are combined in a static environment, the crumb rubber will settle out of the binder. If a binder with separated crumb rubber is used to produce asphalt mixes, a portion of the resulting mix will have excess rubber content, while another portion of the same mix might contain no rubber at all. Both conditions may produce asphalt mixes that do not perform effectively in the field.

Asphalt terminals blending rubber and binder together can experience settling in their tanks before loading the modified binder onto the truck unless the tanks are agitated to keep the rubber evenly dispersed throughout the binder. Terminal blend binders require transport via truck, which can permit separation of rubber and binder in the truck during transit unless the truck has an agitated storage tank. Once the blended binder is either delivered or produced at the asphalt mix plant, the modified binder and crumb rubber will separate unless they are stored in a properly engineered, agitating holding tank. Finally, crumb rubber modified binders can separate when the modified binder is pumped through the asphalt production facility, causing both mix quality problems and plant operating issues.

In general, crumb rubber additions offer three advantages over standard unmodified asphalt mixes: the pavement is stiffer and more rut resistant, the pavement is more flexible and crack-resistant, and the presence of rubber grains in the mix act as crack pinning agents, limiting the spread of cracks as they form. As noted, polymer additions to binders produce a binder that is more resistant to rutting and cracking. However, recycled crumb rubber or polymer modification of asphalt binders in excessive amounts can produce pavements that are hard to compact, brittle and more prone to cracking. It is also possible to add too little polymer or crumb rubber which would limit any beneficiation of pavements from modification. As a general rule, crumb rubber addition rates of less than 5% by weight of virgin binder will have little or no beneficial impact on asphalt performance. When the crumb rubber content exceeds about 25% of the weight of binder in many mix designs, the asphalt mix can become so stiff that it cannot be properly compacted, which leads to premature pavement failure.

As noted, crumb rubber absorption of lighter binder ends causes swelling and softening of the rubber grains. These softer grains of rubber become sticky and more difficult to process, more difficult to unload from trucks and more difficult to place and compact because the mix tends to stick to truck beds, pavers, rollers and hand tools. This increases production and placement costs, and it can further increase the likelihood of pavement performance problems. Most terminal blend and wet process asphalt modification projects use more than 10% rubber content, so special handling procedures, plant engineering and mix modifications (workability agents) are often required.

Road designers and builders are very focused on pavement quality control systems. In the past, acceptance of crumb rubber modified asphalt binders has been withheld by many governmental agencies because of the crumb rubber separation issue. Highly variable binder quality is not acceptable, and the potential for rubber settlement is a risk. That risk is exacerbated by the fact that there are no commonly accepted testing methods for rapidly and accurately quantifying the rubber content in an asphalt mix sample once the mix has been manufactured. Cores of the finished pavement can be collected and the rubber content can be washed out of the samples, but this testing cannot typically be completed during construction. It is also possible to sample the liquid binder while it is being pumped into the asphalt mix production process. Once the sample is taken, it is possible to both test for rubber content or it is possible to test the performance characteristics of the rubber/binder blend using SuperPave testing procedures. In both cases, testing does not offer immediate data on the presence of rubber in the binder before use. In the event there is a problem with proper dispersion of rubber in the mix, it will not be discovered until substantial amounts of pavement are laid. In such cases, the cost of removing and replacing defective pavement is prohibitive. This problem remains a barrier to the use of rubber in asphalt mix designs.

Finally, the economics of waste tire recycling and the costs of adding crumb rubber to binder tend to be equal to or more expensive than those of polymer modification. These economic differences do not reflect the future costs of any measurement technology that can provide immediate field measurement of modification.

The use of crumb rubber in asphalt has grown slowly in the US. Primary issues include quality concerns during production and placement, mix design challenges, production and handling issues past pavement performance issues and economics. As a result, the use of terminal blend or wet process crumb rubber in asphalt mix design represents a very small fraction of the modified asphalt marketplace, both nationally and globally. Use is not increasing rapidly because of these same issues.

### Testing of Crumb Rubber Modified Asphalt Binders and Mixes

Given the extended life of some asphalt roads, it may take fifteen or more years to observe the effects of a new additive or mix design in the field. To reduce the time required to assess the performance of any specific mix designs, the industry is constantly developing and deploying lab testing methods designed to forecast the expected future performance of a mix design. Some of the more prominent testing procedures in common use in the US include evaluations of the binder used or evaluation of mix performance. Regulatory authorities often specify binder performance characteristics that must be met for specific projects. These tests include asphalt binder performance grading under the Federal “SuperPave” system, binder testing with a Bending Beam Rheometer and the Multiple Stress Creep Recovery Test (MSCR). Common mix design tests include the Hamburg Wheel Tracking Test and multiple mix cracking tests like the Semi-Circular Bend Test (SCB) and the Disc-Shaped Compact Tension (DSC) test.

Although binder testing methods offer effective tools for forecasting binder performance in the field, they do not always work well with crumb rubber modified binders. That is because without further chemical modification of many asphalt binders blended with rubber, crumb rubber modified asphalts do not consistently test well in the lab. Since crumb rubber combination with liquid asphalt makes mechanical changes in the binder, crumb rubber modified binders test often show a propensity for rapid cracking in the lab. Although rubberized asphalt is very effective in resisting cracking in the field, poor testing performance often means that many regulatory agencies will not permit widespread use of rubber in asphalt mixes.

These problems have encouraged many regulatory agencies to consider mix testing or mix performance testing as either an alternative to focused binder testing or as a supplement to binder testing. This “Balanced Mix Design” approach or performance testing offer improved testing methods for technologies incorporating rubber in asphalt.

### Dry Process Crumb Rubber Modified Asphalt Mixes

There is another method for introducing rubber to asphalt mix designs: the Dry Process. This is a method that involves the introduction of rubber into the asphalt mix production process much like a fine aggregate. This process avoids pre-mixing of rubber and binder and all of the associated quality, handling and storage challenges. Crumb rubber is added to the mixing process along with heated stone and sand, and then heated liquid asphalt and other chemical additives are added to the mix. This method was employed three decades ago as the PlusRide process, where coarse-grained recycled tire rubber was added to the asphalt mix like sand or fine gravel. The process was only marginally successful, probably due in part to the complexities of adding very large rubber grains to the asphalt mix. After several years of trial and error, the market generally abandoned this dry addition process for the more common terminal blend and wet process crumb rubber modified binders. Pavement performance issues were commonly cited reasons for abandoning PlusRide.

Although there were general performance complaints about the quality of dry process asphalts when PlusRide was evaluated, some of the problems were more complex. One of the problems of the early dry process designs was the size of the crumb rubber used. As noted above, the use of rubber in asphalt mixes or binders includes covering the rubber grains with heated, liquid asphalt binder, followed by light end absorption of the binder in the surface pores of the rubber. This causes the rubber grains to swell and soften while helping to stiffen the mix, and the swollen rubber grains serve to make the pavement materials more flexible as well as serving as a more effective crack pinning agent. Larger crumb rubber grain sizes will exhibit less swollen surface area and softening per unit volume of rubber, lower volumes of swollen rubber in the mix, and less crack pinning capability when compared to equal weights of finer rubber. (A unit volume of 30 minus crumb rubber can have greater than an order of magnitude more surface area than a unit volume of ¼ inch crumb rubber). As crumb rubber grain sizes fall, interactive surface areas, swelling potential, binder uptake and crack pinning potential will increase.

A second problem with early dry process experiments was control of crumb rubber inputs. Dry process rubber requires the addition of crumb rubber like other fine aggregates, and this involves the use of some sort of feeder system that will match crumb rubber inputs with the operating speed of an asphalt production facility. When such feeder systems are applied, larger, more angular, higher surface roughness crumb rubber will tend to resist controlled gravity flow through a metered feeder system. Typical rubber additions to asphalt plant operations are less than 0.5% of the total material inputs to the asphalt plant during standard production operations, so small variations in feeder accuracy could have the same impact as settling of wet process rubber products before use.

A third problem with the dry process is common to all rubberized asphalt products. Crumb rubber additions beyond approximately 0.4% of the mix weight can produce a range of problems associated with a sticky, less workable asphalt mix during production, handling, transport and compaction.

A fourth problem with the dry process had to do with rubber function during mix preparation. As noted, crumb rubber will absorb light ends of the virgin binder added to the mix design. The addition of supplemental absorptive fine materials (crumb rubber) to an asphalt mix will draw a fraction of the binder into the rubber pores. A failure to compensate for this supplemental binder demand could produce a mix with a reduced and insufficient binder content. This would mean that some aggregate in the mix would be coated with an insufficient amount of asphalt binder. Drier mixes tend to strip and crack prematurely.

As noted, the use of rubber in asphalt can be accomplished through the use of both wet/terminal blend and dry processes. Current and past attempts to use these processes effectively have been impeded by process design, mix design process engineering, cost, and quality control issues. These issues have slowed or stopped the widespread adoption of rubber in asphalt pavements.

### SUMMARY

According to an aspect of the present disclosure, an engineered crumb rubber asphalt additive comprises a plurality of a structural particles and a non-elastomeric liquid. At least a portion of the surface of the structural particles is coated with the non-elastomeric liquid. Optionally, the non-elastomeric liquid may be selected from the group consisting of workability agents, slipping agents, compaction agents, and anti-stripping agents. Optionally, the structural particles may be crumb rubber particles. Optionally, the crumb rubber particles may be selected from the group consisting of rubber ground through ambient processing, rubber ground through cryogenic processing, recycled rubber, vulcanized rubber, and un-vulcanized rubber. An asphalt composition may comprise the engineered crumb rubber asphalt additive and a heated asphalt mix. An asphalt mix may comprise the engineered crumb rubber asphalt additive, gravel, sand, and binder. The asphalt mix may be dense graded asphalt mix, gap graded asphalt mixes, porous mixes, open graded mix, or stone matrix asphalt mixes. The asphalt mix may be used to produce a chip seal surface.

According to another aspect of the present disclosure, an engineered crumb rubber asphalt additive comprises a plurality of structural particles, one or more non-elastomeric liquids; and a reagent. At least a portion of the surface of the structural particles is coated with both the one or more non-elastomeric liquids and the reagent. Optionally, the reagent may be a solvent. Optionally, the one or more non-elastomeric liquids are self-hardening.

According to another aspect of the present disclosure, an engineered crumb rubber asphalt additive comprises a plurality of structural particles, a liquid non-elastomeric coating disposed on said structural particles, and a reagent disposed on said liquid non-elastomeric coated structural particles to create a hardened chemically-bonded coating on the surface of said structural particles.

According to another aspect of the present disclosure, a method for producing an engineered crumb rubber asphalt additive comprises the step of adding a non-elastomeric liquid to a plurality of structural particles wherein the non-elastomeric liquid coats a least a portion of the surface of the structural particles. Optionally, the method may comprise the step of mixing the structural particles and non-elastomeric liquid chemical to form a coating on at least one portion of the surface of the structural particles. Optionally, the structural particles and non-elastomeric liquid chemical may be mixed using a paddle mixer, a ribbon blender or mixer, a V blender, a continuous processor, a cone screw blender, a counter-rotating mixer, a double & triple shaft mixer, drum blenders, a intermix mixer, a horizontal mixer, or a vertical mixer. The mixing process may be a wet process or a dry process. Optionally, the structural particles and non-elastomeric liquid chemical may be mixed using belts, augers, metered feeding, pneumatic feeding, or a loss in weight feeder. Optionally, the structural particles and non-elastomeric liquid chemical may be mixed with an asphalt mix using aggregate feed belts, RAP collar, pug mill or other locations. Optionally, the method may further comprise the step of adding a reagent to the non-elastomeric liquid or liquids. Optionally, the engineered crumb rubber asphalt additive may be produced by first mixing a non-elastomeric liquid chemical and reagent before mixing with the structural particles to form a coating on at least one portion of the surface of the structural particles.

It is to be understood that both the foregoing general description and the following detailed description describe various embodiments and are intended to provide an overview or framework for understanding the nature and character of the claimed subject matter. The accompanying drawing is included to provide further understanding, and is incorporated into and constitutes a part of this specification. The drawing illustrates an embodiment described herein, and together with the description serve to explain the principles and operations of the claimed subject matter. Other objects, advantages and novel features of the present invention will become apparent from the following detailed description of one or more preferred embodiments when considered in conjunction with the accompanying drawing.

### BRIEF DESCRIPTION OF SEVERAL VIEWS OF THE DRAWINGS

The following is a description of the examples depicted in the accompanying drawing. The figure is not necessarily to scale, and certain features and certain views of the figure may be shown exaggerated in scale or in schematic in the interest of clarity or conciseness.

FIG. 1 shows a schematic of a coated crumb rubber particle.

FIG. 2 shows a schematic of a coated crumb rubber particle.

FIG. 3 shows a schematic of an asphalt plant and engineered crumb rubber (ECR) feeder.

FIG. 4 shows a flow chart showing an example method of preparing an engineered crumb rubber (ECR) additive.

FIG. 5 shows a flow chart showing an example method of preparing ECR asphalt.

The preceding summary, as well as the following detailed description of certain embodiments of the present invention, will be better understood when read in conjunction with the appended drawing. For the purposes of illustration, certain embodiments are shown in the drawing. It should be understood, however, that the claims are not limited to the arrangements and instrumentality shown in the attached drawing. Furthermore, the appearance shown in the drawing is one of many ornamental appearances that can be employed to achieve the stated functions of the system.

### DETAILED DESCRIPTION

In the following detailed description, specific details may be set forth in order to provide a thorough understanding of embodiments of the present invention. However, it will be clear to one skilled in the art when embodiments of the present invention may be practiced without some or all of these specific details. In other instances, well-known features or processes may not be described in detail so as not to unnecessarily obscure the invention. In addition, like or identical reference numerals may be used to identify common or similar elements.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. As used herein, “approximately” may generally refer to an approximate value that may, in certain embodiments, represent a difference (e.g., higher or lower) of less than 1% from the actual value. That is, an “approximate” value may, in certain embodiments, be accurate to within (e.g., plus or minus) 1% of the stated value. In certain other embodiments, as used herein, “approximately” may generally refer to an approximate value that may represent a difference (e.g., higher or lower) of less than 10% or less than 5% from the actual value.

The present technology is directed to a dry process for asphalt mix modification. This dry process employs the use of a unique engineered crumb rubber (ECR) asphalt mix modifier introduced like a fine aggregate during the production of asphalt mixes for use in asphalt paving applications. The ECR is precisely metered into the asphalt mix production process like a powder or fine aggregate.

According to the present disclosure, one may produce asphalt binders and mixes that include crumb rubber. As noted, crumb rubber modified asphalt binders can separate during transport and production, creating potential quality problems in asphalt mix production. In production, rubberized asphalt mixes tend to be difficult to produce because of higher binder viscosity, stickiness and separation. Due to the heated, softened and swollen rubber content, rubberized asphalt mixes are often sticky, harder to handle, transport, unload and compact.

When this ECR additive is used in an asphalt mix design, the following benefits accrue: (1) the mix is no more difficult to produce, handle, transport and place than standard unmodified hot or warm mix asphalt (2) the mix will readily compact and will not adhere to compaction tooling and equipment, (3) the ECR will permit a reduction in warm mix additives commonly used in asphalt production. Metered feeding of ECR into the asphalt production process will eliminate the risk of rubber/binder separation and associated pavement quality problems. The use of an ECR and a metered feeding process permits the production of crumb rubber modified asphalt in a manner more efficient than previously disclosed methods.

According to the present disclosure, the ECR asphalt mix modifier may be manufactured by coating at least a portion of the surface of crumb rubber particles with one or more non-elastomeric liquid chemicals. In some instances, the asphalt additive is manufactured by coating at least a portion of the surface of the crumb rubber particles with a non-elastomeric liquid. Some embodiments include methods for producing an asphalt additive comprising adding a non-elastomeric liquid to a plurality of crumb rubber particles wherein the non-elastomeric liquid coats a least a portion of the surface of the crumb rubber particles.

Non-limiting examples of the non-elastomeric liquids include workability/compaction agents, anti-stripping agents, slipping agents, glycols, organosilanes, rejuvenators, and water. Non-limiting examples of workability/compaction agents include Evotherm (DAT, 3G), Sasobit, Vestenamer, Zycotherm, Zycosoil, Rediset (WMX, LQ), Advera, Cecabase RT, Sonnewarmix, Hydrogreen, Aspha-Min, and QPR Qualitherm. Non-limiting examples of anti-stripping agents include hydrated lime, hydrated lime slurry, Anova 1400, Anova 1410, Fastac, Evotherm (J12, M1, M14, U3), Morlife (5,000, T280), Pave Bond Lite, Pavegrip 550, Ad-here (77-00LS, HP PLUS Type 1, HP PLUS with Cecabase-RT 945, LOF 65-00, LOF 65-00 LSI, LOF 65-00 EU), Nova Grip (1016, 975, 1012), Zycotherm, Zycotherm (EZ, SP), Kohere (AS 700, AS 1000, AT 1000), Pavegrip 200, and Surfax AS 500. Non-limiting examples of slipping agents include industrial waxes, trans-polyoctenamer rubber (TOR) and polymethylsiloxane. Those skilled in the art may add other additives (apart from those listed) as, for example, workability/compaction agents, anti-stripping agents, rejuvenators, or slipping agents.

In some instances the modified rubber is produced by coating at least a portion of the surface of the crumb rubber with at least two non-elastomeric liquids. In yet another instance the modified rubber is produced by coating at least a portion of the surface of the crumb rubber with a plurality of non-elastomeric liquids.

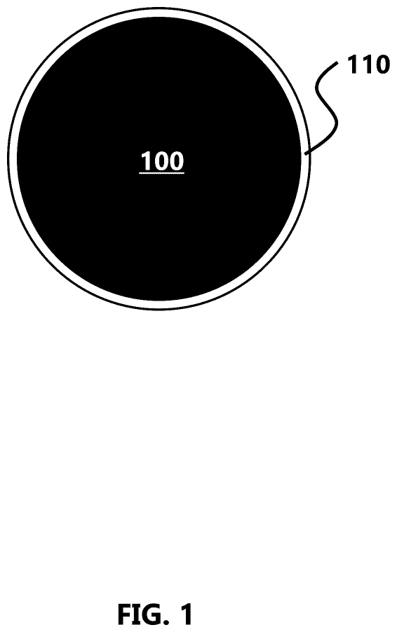

In some embodiments, an ECR asphalt mix modifier is produced by mixing the crumb rubber 100 and non-elastomeric liquid chemical to achieve a coating 110 on at least a portion of the crumb rubber 100, as shown schematically in FIG. 1. The crumb rubber can be vulcanized or un-vulcanized. This mixing can be done, for example, using a paddle mixer, a ribbon blender or mixer, a V blender, a continuous processor, a cone screw blender, a counter-rotating mixer, a double & triple shaft mixer, drum blenders, a intermix mixer, a horizontal mixer, or a vertical mixer. One of skill in the art will appreciate that mixing can be synonymous with other terms such as blending.

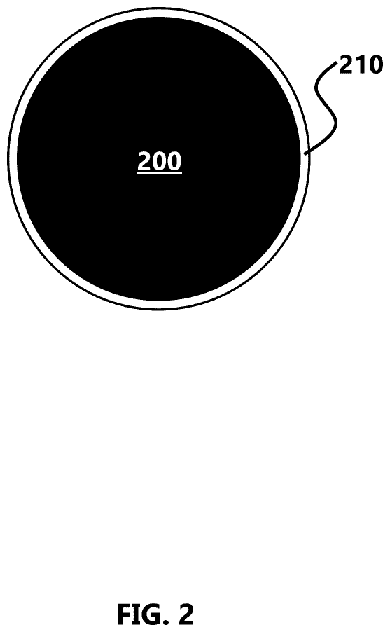

In some embodiments, an ECR asphalt mix modifier is produced by first mixing a non-elastomeric liquid chemical and reagent before mixing with the crumb rubber 200 to form a coating 210 on at least one portion of the crumb rubber 200, as shown schematically in FIG. 2. The crumb rubber may be vulcanized or un-vulcanized. This process will produce a dry coating that is firmly attached to the rubber and will not readily separate. The coating will not change the handling characteristics of the coated crumb rubber.

In some embodiments, when the ECR is added to a heated asphalt mix, the modified asphalt additive reduces the stickiness modified asphalt mix. In this instance the mix modification does not negatively impact the performance of the modified asphalt mix when used in paving applications.

In some embodiments, the ECR asphalt mix modifier is produced by combining a wet, non-elastomeric element with vulcanized or un-vulcanized crumb rubber to form a coating on at least one portion of the crumb rubber. In this embodiment, the resultant modified asphalt additive can be used in the manufacture of hot or warm mix asphalt.

In some embodiments, the ECR asphalt mix modifier is produced by combining a wet, non-elastomeric element with vulcanized or un-vulcanized crumb rubber to form a coating on at least one portion of the crumb rubber. In some embodiments the non-elastomeric coating element is self-hardening. This allows for low-variability flow of the coated rubber grains into granular material metered feeder systems-meaning that the addition rate can't make the rubber sticky so that it has a highly variable flow rate in a metered feeding system. This embodiment also allows for low-variability flow of the coated rubber grains into, for example, a pneumatic feeder system, an auger-driven feeder system or a belt feeder system.

In some embodiments, the ECR asphalt mix modifier comprises a plurality of structural particles; a liquid non-elastomeric coating disposed on said structural particles; and a reagent disposed on said liquid non-elastomeric coated structural particles to create a hardened chemically-bonded coating on the surface of said structural particles. In certain embodiments, the reagent may be the liquid non-elastomeric coating. In other embodiments, the reagent may be a second liquid non-elastomeric coating. In further embodiments the structural particles are crumb rubber particles. The crumb rubber can be from a variety of rubber sources such as rubber ground through ambient processing and rubber ground through cryogenic processing. In some embodiments the rubber is a recycled rubber such as one that is made from auto tires and/or truck tires. In one embodiment, the auto or truck tires may be waste tires. In another embodiment the crumb rubber is made from vulcanized rubber. In another embodiment the crumb rubber is made from un-vulcanized rubber.

In some embodiments, the size of the structural particles may range between smaller than 16 mesh (which may be referred to as “minus 16 mesh,” meaning that the structural particles pass through a mesh having square openings that are 1/16th of an inch wide, and thus that the diameters of the structural particles are smaller than 1/16th of an inch) and larger than 300 mesh (which may be referred to as “plus 300 mesh,” meaning that the structural particles do not pass through a mesh having square openings that are 1/300th of an inch wide, and thus that the diameters of the structural particles are larger than 1/300th of an inch). In some embodiments, the size of the structural particles may range between minus 20 mesh and plus 300 mesh. In some embodiments, the size of the structural particles may range between minus 30 mesh and plus 150 mesh. In some embodiments, the size of the structural particles may range between minus 40 mesh and plus 60 mesh. In other embodiments, different combinations of mesh openings between minus 16 mesh and plus 300 mesh may be used. The recycling of crumb rubber can be inherently variable because cutting tools may vary in sharpness over time (e.g., the tools may become duller over time), producing some size variation in the product. As used in the present disclosure, the “size” of the structural particles refers to the size of the majority (at least approximately 90%) of the structural particles; as such, there may thus be a minority of structural particles (up to approximately 10%) that fall outside of the stated size range (either larger or smaller). Thus, “majority” as used in the present disclosure with respect to the size of structural particles means that at least approximately 90% of the structural particles have the stated size. The “minority” of structural particles are thus the up to approximately 10% of structural particles that are either oversize or undersize (as compared to the stated size range or value. Also, the size of the structural particles refers to the size of uncoated structural particles, which may be made from either vulcanized or un-vulcanized rubber.

In some embodiments, the ECR asphalt mix modifier is added to an asphalt mix. In further embodiments this asphalt mix comprises gravel, sand and binder. The asphalt mix may be, for example, dense graded asphalt mix, gap graded asphalt mixes, porous mixes, open graded mix, or stone matrix asphalt mixes. The asphalt mix may be, for example, used to produce a chip seal surface.

In some embodiments, the structural particles and non-elastomeric liquid chemical are mixed into the binder and heated before mixing with aggregate. In other embodiments, the structural particles and non-elastomeric liquid chemical are mixed with the aggregate before the addition of asphalt binder.

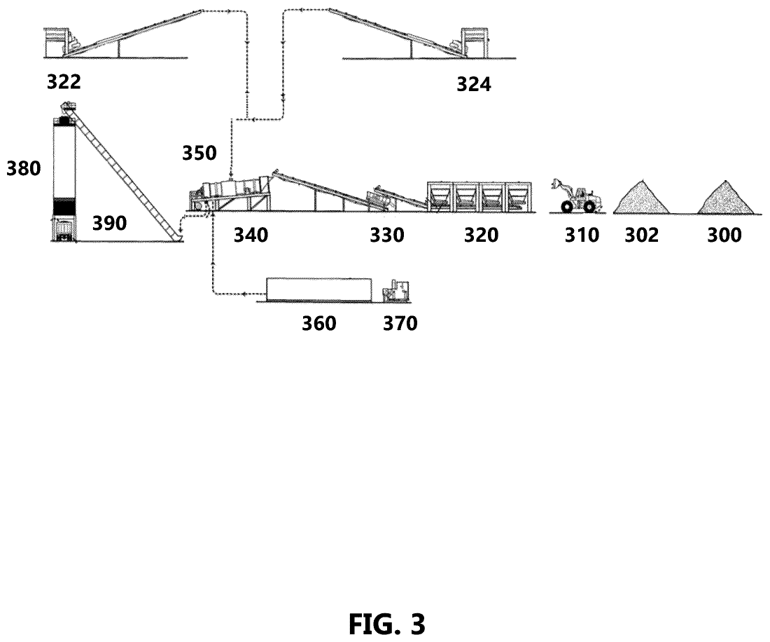

FIG. 3 shows a schematic of an example asphalt production plant with ECR modification. Coarse aggregate 300 and fine aggregate 302 are moved by front end loader 310 to feeders 320 that meter various aggregate mix designs through a scalping screen 330, then convey the screened aggregate to a rotating heated drum 340 where the aggregate is heated and mixed. In many mix designs, Recycled Asphalt Pavement (RAP) is fed into the drum via a feeder system 322 through a collar on the drum 350. In mix designs using the Engineered Crumb Rubber (ECR) referenced in this application, the ECR is metered into the drum using a metered feeder 324 or 320 (located at either location as indicated). A heating system 370 keeps the asphalt binder stored in a tank 360 in a liquid state so that the binder can be pumped into the rotating drum 340 where it is mixed with aggregate, RAP, and rubber to make a warm or hot mix asphalt. The heated mix is transported by belt or auger to a holding silo 380, after which it is loaded onto trucks 390 for transport to a paving project.

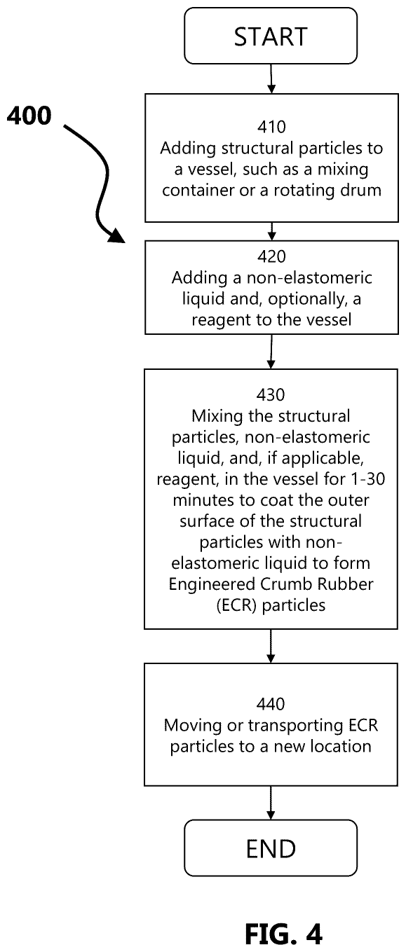

FIG. 4 shows a flow chart illustrating an example method 400 of preparing engineered crumb rubber (ECR) particles. During step 410, a plurality of structural particles (such as crumb rubber particles) are added to a vessel, such as a mixing container or a rotating drum. During step 420, a non-elastomeric liquid is added to the vessel. The non-elastomeric liquid may be a binder or may include a binder. Along with the non-elastomeric liquid, a reagent such as a solvent may be added to the vessel. Along with the non-elastomeric liquid, aggregate may also be added to the vessel. Along with the non-elastomeric liquid, further non-elastomeric liquids may also be added to the vessel. During step 430, the contents of the vessel (at least the structural particles and the non-elastomeric liquid) are mixed for between 9 seconds and 30 minutes, for example, from 9 seconds to 1 minute, 1 to 5 minutes, 5 to 10 minutes, 10 to 15 minutes, 15 to 20 minutes, 20 to 25 minutes, or 25 to 30 minutes. According to certain embodiments, the structural particles may be crumb rubber particles that range in size from between smaller than 16 mesh and larger than 300 mesh. During the mixing step 430, the non-elastomeric liquid adheres to and coats the surface of the structural particles. The mixing step 430 may be conducted at an ambient temperature. By keeping the mixing step 430 at an ambient temperature and limiting the time of mixing, the structural particles do not have sufficient opportunity to swell or become sticky, and are thus still able to be handled or transported easily, similar to an unmodified crumb rubber. Mixing the plurality of structural particles with at least one non-elastomeric liquid forms an asphalt additive that may be referred to as engineered crumb rubber (ECR) particles. An advantage of these ECR particles is that they can be easily transported to, or pneumatically or mechanically fed into, an operating asphalt plant as an asphalt mix modifier. During the moving or transporting step 440, the ECR particles are moved or transported to a second location, such as an operating asphalt plant as shown in FIG. 3.

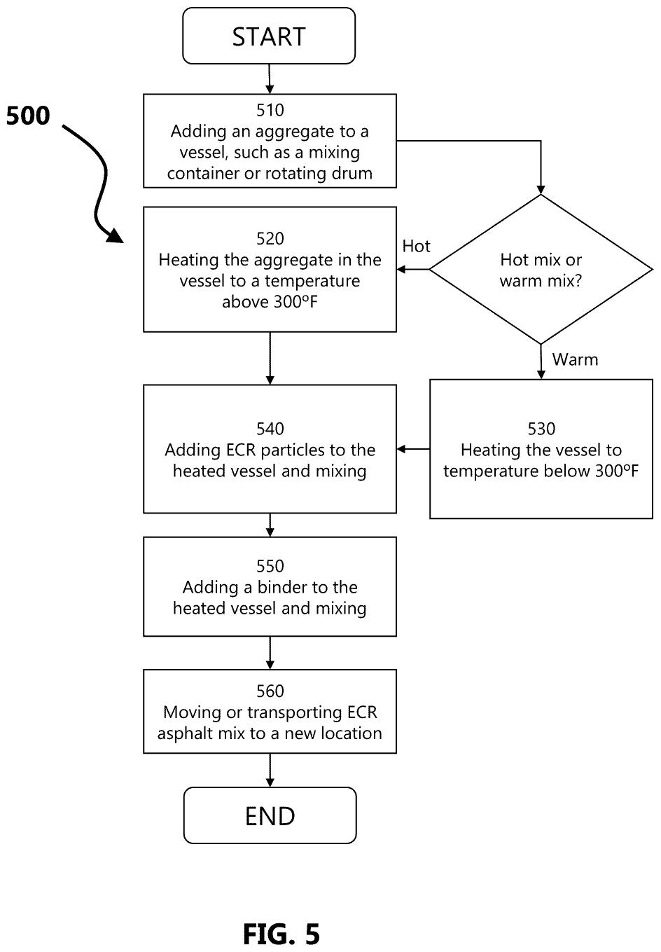

FIG. 5 shows a flow chart illustrating an example method 500 of preparing an ECR asphalt mix. During step 510, an aggregate is added to a vessel, such as a mixing container or a rotating drum. The aggregate may be coarse or fine aggregate (such as 300 or 302, respectively, in FIG. 3). In certain embodiments, the aggregate may comprise coarse and fine aggregate. The aggregate may be mixed in a hot mix 520 or in a warm mix 530. In a hot mix 520, the aggregate is heated to above 300° F. and maintained at a temperature above 300° F. In a warm mix 530, the aggregate is heated to below 300° F. and maintained at a temperature below 300° F. A person of ordinary skill in the art would understand that a mix below 300° F. is considered a warm mix while a mix above 300° F. is considered a hot mix. Next, in step 540 a plurality of ECR particles are added to the heated vessel (for both a hot mix 520 or a warm mix 530). According to certain embodiments, the plurality of ECR particles may be metered into the heated vessel 340 using a metered feeder 320 or 324 and mixed together with the aggregate mix in rotating drum 340 as shown in FIG. 3. According to certain embodiments, the ECR particles are added to the aggregate mix after the aggregate mix has been heated so to prevent degradation of the ECR particles. In other words, the ECR is added “down process” to prevent the ECR from melting and to prevent the ECR and aggregate mix from becoming sticky or gummy.

During step 550, an asphalt binder is added. The asphalt binder may be added to the mix by pumping the asphalt binder from a tank 360 to a rotating drum 340, as shown in FIG. 3. During step 550, the asphalt binder, aggregate, and ECR particles are mixed together, for example to form an ECR modified asphalt mix that may be used for paving a surface such as a road. During step 550, the asphalt binder is a heated asphalt binder and is added at a temperature of about 280-350° F. According to certain embodiments, asphalt binder may alternatively be added earlier, for example immediately after step 510, so that the asphalt binder is added to the aggregate before adding the ECR particles.

During step 560, the resulting asphalt mix may be transported to a new location, for example, a construction site where a road is being paved. As shown in FIG. 3, after the asphalt mix is transported via belt or auger to holding silo 380, the asphalt mix is loaded onto trucks 390 and transported to a paving project. As such, the example method may end at after step 560. In some embodiments, methods 400 and 500 may be prepared in the same location, or, alternatively, may be prepared at a construction site or paving project.

During and after step 550, including during transport at step 560, the asphalt additive, i.e., the ECR particles, is reacting with the asphalt binder. In the preferred embodiment, when the asphalt binder has a temperature above 270° F., absorption of the lighter ends of the asphalt binder through the pores on the surface of the crumb rubber particles increases, resulting in increased swelling. The ECR particles may advantageously swell to about double to triple the original volume of the crumb rubber particles. The absorption or adsorption of the asphalt binder occurs as a result of the physical properties of the structural particles such as the surface effect forces that include the surface tension of the pores, the van der Waals forces, and the capillary forces, all of which contribute to the absorption of the asphalt binder. The absorption or adsorption of the asphalt binder also occurs as a result of the diffusion-induced volume expansion produced by the concentration difference between the asphalt binder and the crumb rubber particles. For example, diffusion of the asphalt binder into the crumb rubber particles will occur until the concentration of the lighter ends of the asphalt binder inside and outside of the crumb rubber particles are equal, wherein the swelling will reach equilibrium. In some embodiments, diffusion rates are higher with increased temperatures of the asphalt binder above 270° F. The rate at which the structural particles absorb the asphalt binder such that the ECR particles swell to equilibrium doubles every 10 degrees. For example, when the asphalt binder or the asphalt mix is at about 320° F., the ECR will swell to equilibrium in about 10 minutes. At about 310° F., the ECR will swell to equilibrium in about 20 minutes. At about 300° F., the ECR will swell to equilibrium in about 40 minutes. At about 290° F., the ECR will swell to equilibrium in about 80 minutes. As such, during steps 550 and 560, the asphalt additive reacts with the asphalt binder, i.e., ECR swelling, for a reaction time between about 10-160 minutes.

The time from when the asphalt mix is formed in step 550 to when it is laid out on a surface is a key factor in the workability and performance of the asphalt mix that may be impacted by the stickiness of the crumb rubber particles. The temperature of the asphalt binder or asphalt mix is preferably 280-350° F., and the size of the crumb rubber particles is preferably about 30-300 mesh, so to reduce the time that the ECR will swell to equilibrium, preferably to about 10-60 minutes. In the preferred embodiment, the plurality of structural particles are coated with at least one non-elastomeric liquid so that the crumb rubber particles swell to about equilibrium either during step 550 or during step 560. Therefore, by the time the asphalt mix starts to become sticky, the asphalt mix is already at the construction site or is being laid out on a surface such that the aforementioned problems with asphalt mix stickiness are substantially eliminated. A person of ordinary skill in the art would understand that as the temperature of the asphalt binder or asphalt mix reduces, it is advantageous for the crumb rubber particles to have increased time to absorb the asphalt binder to increase swelling to equilibrium.

An advantage of the example method and ECR product is that the size of the crumb rubber particles and reaction time between the asphalt binder and the ECR are reduced, while still permitting increased swelling of the crumb rubber particles. The non-elastomeric liquid helps to ensure that the asphalt binder more evenly coats the structural particles and aggregate, helping to ensure rapid swelling in the asphalt mix. In the preferred embodiment, the swollen grains of crumb rubber particles help the asphalt mix resist both rutting and cracking, thus helping to extend pavement life and improve the sustainability of the road.

### Example 1

In this example, an ECR asphalt mix modifier was used in demonstration projects on a heavily-travelled interstate highway in the Northern Plains. This is an area with significant truck traffic, high summer heat, sub-zero winter air temperatures, and a high frequency of freeze-thaw events. The ECR-based mix designs incorporated in the project were built around two stone mastic asphalt (SMA) mix designs with polymer-modified asphalt. Instead of using a 70-28 performance-graded polymer modified (stiff) asphalt binder, the ECR mix used a 58-28 performance graded (softer) binder with a mix modification including 10% ECR by weight of virgin binder. Both mix designs had 12.1% recycled asphalt pavement (RAP) and 5% recycled asphalt shingles (RAS) content with a design binder content of 6%. Testing of the polymer modified mix produced Hamburg Test rutting of 2.06 mm of rut after 20,000 passes and a DCT (Disc-shaped Compact Tension) Test scoring of 566. Mixes produced with ECR mixing generated testing results of 2.51 mm of rut on the Hamburg Test after 20,000 passes and 602 on the DCT. Both mix designs are roughly compatible in performance testing. Multiple year field trial results show comparable field performance between the ECR asphalt mix designs and polymer modified asphalt mix designs.

### Trial Results Summary

| | HAMBURG TEST | DCT |
|---|---|---|
| MIX DESIGN | RESULTS | RESULTS |
| POLYMER MODIFIED SMA | 2.06 mm | 566 |
| ECR MODIFIED SMA | 2.51 mm | 602 |

### Example 2

In this example, ECR was used as an asphalt modifier in demonstration projects on a heavily-travelled interstate highway in the Northern Plains. As noted above, this is an area with significant truck traffic, high summer heat, sub-zero winter air temperatures, and a high frequency of freeze-thaw events. ECR mix designs were compared with terminal blend crumb rubber modified asphalt mix designs, both in the lab and field.

The ECR-based mix designs incorporated in the project were built around one SMA mix originally designed with 70, −28 polymer-modified asphalt. 58, −28 and 46, −34 performance graded binders were used as the base binder in a series of mix designs that included moderate levels of asphalt binder replacement with recycled asphalt shingles (RAS) and recycled asphalt pavement (RAP). These mix designs were designed with the same base binders and modified with either terminal blend rubber or ECR. The terminal blend crumb rubber modified binders used 12% by weight rubber content. The ECR design mixes used 10% by weight of virgin binder rubber content.

Mix testing demonstrated the following:
For the 58, −28 base binder (soft binder) mix designs, terminal blend rubber mix designs exhibited a 3.85 mm rut under Hamburg Wheel Testing, while the ECR mix designs exhibited a rut of 3.12 mm. Crack testing using the I-FIT semicircular bend cracking test showed results of 3.51 for the terminal blend rubber mix designs and 4.14 for the ECR mix designs. In both sets of mix testing results, ECR mixes outperformed terminal blend rubber mixes while using 17% less rubber content.
For the 46, −34 base binder (very soft binder) mix designs, terminal blend rubber mix designs exhibited a 5.29 mm rut under Hamburg Wheel Testing, while the ECR mix designs exhibited a rut of 3.2 mm. Crack testing using the I-FIT semicircular bend test showed results of 4.55 for the terminal blend rubber mix designs and 6.42 for the ECR crumb rubber mix designs. In both sets of mix testing results, the ECR mixes outperformed terminal blend rubber mixes while using 17% less rubber content.

Multiple year field trial results show comparable field performance between ECR and terminal blend rubber modified designs.

Additional evaluation of these SMA mix designs included an evaluation of the workability and compactability of the mix following the addition of ECR. The standard SMA mix designs on the project included the addition of a commonly used “warm mix” additive designed to allow easier compaction of the mix following placement at lower compaction temperatures. Laboratory testing of the mix compaction requirements revealed that with the use of approximately 8 lbs. of ECR in the mix design, the use of warm mix additives could be reduced by more than 50%.

### Trial Results Summary

| | HAMBURG TEST | IFIT |
|---|---|---|
| MIX DESIGN | RESULTS | RESULTS |
| 58-28 BINDER | | |
| TERMINAL BLEND RUBBER | 3.85 | 3.51 |
| ENGINEERED CRUMB RUBBER | 3.12 | 4.14 |
| 46-34 BINDER | | |
| TERMINAL BLEND RUBBER | 5.29 | 4.55 |
| ENGINEERED CRUMB RUBBER | 3.20 | 6.42 |

### Example 3

In this example, ECR was used to modify an SMA mix design and the modified product was used on a test pavement section located on a heavily-traveled interstate highway near a major urban metropolitan area in the southern Central Plains of the United States. The area climate is characterized by cold winters with a moderately high freeze-thaw frequency, very hot summers and relatively high amounts of precipitation.

The base SMA mix design included no Rap or RAS, and a 6% binder content using a polymer-modified 70, −28 performance-graded binder.

During production of the crumb rubber modified mix designs, ECR was fed into the production process with the use of a loss-in-weight pneumatic feeder system (See FIG. 3). The flow of ECR into the mixing plant was measured every 45 seconds throughout the production run. Based on the operating tempo of the production plant, the target feed rate for ECR was 52 lbs. a minute. The field mean output of the unit averaged 52.13 lbs. per minute with a three-minute standard deviation of 1.3 lbs., indicating that the flow of ECR into the asphalt mix production process is both consistent and accurate. This also indicated that the distribution of rubber in the mix output was consistent as well.

Testing of lab-generated mix performance revealed the following characteristics for the polymer modified mix design: Hamburg testing with a 12.5 mm rut and DCT testing scoring 662. The higher levels of rut were due to the characteristics of the aggregate used for paving in the region, and the cracking resistance of the mix was considered good.

A similar mix design was produced with the same aggregate but with a 58, −28 binder and 10% by weight ECR substituted for the 70, −28 polymer modified binder. Testing of this lab-generated mix performance revealed the following characteristics: Hamburg testing with a 6.7 mm rut and DCT testing scoring 690. Although the higher levels of rut are due to the characteristics of the aggregate used for paving in the region, the rutting resistance of the rubber modified mix design was higher than the polymer modified mix design. The cracking resistance of the mix was considered excellent.

Both mix designs were produced at an operating production facility and used in a demonstration project on an interstate highway. Field mixes were tested after production and compaction. Because this was a thin lift application, rutting test data on cores were unavailable, but DCT testing indicated that the polymer modified mix scored a 715 while the rubber modified mix scored an 884. This suggests that the rubber modified asphalt is materially more resistant to cracking when compared to polymer modified asphalts in a similar mix design.

Additional evaluation of this SMA mix design included an evaluation of the workability and compactability of the mix following the addition of ECR. The standard SMA mix design on the project included the addition of a commonly used “warm mix” additive designed to allow easier compaction of the mix following placement at lower compaction temperatures. Laboratory testing of the mix compaction requirements revealed that with the use of approximately 12 lbs. of ECR in the mix design, no warm mix additives were required to provide easier compaction at the same compaction temperatures found with the use of a warm mix additive.

### Trial Results Summary

| | HAMBURG TEST | DCT |
|---|---|---|
| MIX DESIGN | RESULTS | RESULTS |
| LAB GENERATED SAMPLES | | |
| POLYMER MODIFIED SMA | 12.5 mm | 662 |
| ECR MODIFIED SMA | 6.7 mm | 690 |
| ASPHALT FIELD SAMPLES | | |
| POLYMER MODIFIED SMA | | 715 |
| ECR MODIFIED SMA | | 884 |

Some of the elements described herein are identified explicitly as being optional, while other elements are not identified in this way. Even if not identified as such, it will be noted that, in some embodiments, some of these other elements are not intended to be interpreted as being necessary, and would be understood by one skilled in the art as being optional.

While the present disclosure has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present disclosure is not limited to the particular implementations disclosed. Instead, the present disclosure will include all implementations falling within the scope of the appended claims, both literally and under the doctrine of equivalents.

What is claimed is:

1. A method for producing an engineered asphalt additive comprising the steps of:
adding a plurality of structural particles to a first vessel;
adding at least one non-elastomeric liquid to the first vessel; and
mixing the plurality of structural particles with the at least one non-elastomeric liquid in the first vessel for between 1 and 30 minutes to produce an engineered asphalt additive.

2. The method of claim 1, wherein the mixing step lasts for between 1 and 5 minutes.

3. The method of claim 1, wherein the mixing step occurs at an ambient temperature.

4. The method of claim 1, wherein the at least one non-elastomeric liquid coats at least a portion of a surface of each of the plurality of structural particles.

5. A method for producing a modified asphalt mix comprising the steps of:
adding an aggregate to a second vessel;
heating the aggregate in the second vessel to an elevated temperature;
adding the engineered asphalt additive of claim 1 to the second vessel;
adding heated asphalt binder to the second vessel; and
mixing the aggregate with the engineered asphalt additive of claim 1 and the heated asphalt binder to produce a modified asphalt mix.

6. The method of claim 5, wherein the asphalt binder is heated to a temperature between 280-350 degrees Fahrenheit.

7. The method of claim 6, wherein the mixing step lasts for between 9 seconds and 5 minutes.

8. The method of claim 5, wherein during the mixing step, the plurality of structural particles of the engineered asphalt additive swell up to a volume larger than their original volume.

9. The method of claim 5, wherein the elevated temperature is a temperature between 280 and 350 degrees Fahrenheit.

10. The method of claim 5, wherein the elevated temperature is a temperature between 270 and 300 degrees Fahrenheit.

11. The method of claim 1, wherein the non-elastomeric liquid is selected from the group consisting of workability/compaction agents, slipping agents, rejuvenation agents, and anti-stripping agents.

12. The method of claim 1, wherein the structural particles are crumb rubber particles.

13. The method of claim 1, wherein the structural particles are crumb rubber particles and are selected from the group consisting of rubber ground through ambient processing, rubber ground through cryogenic processing, recycled rubber, vulcanized rubber, and un-vulcanized rubber.

14. The method of claim 1, wherein the structural particles are comprised of recycled rubber from auto tires, truck tires, waste auto tires, waste truck tires, or any combination thereof.

15. The method of claim 1, wherein a majority of the structural particles have a size between minus 16 mesh and plus 300 mesh.

16. The method of claim 15, wherein a majority of the structural particles have a size between minus 30 mesh and plus 300 mesh.

17. The method of claim 16, wherein a majority of the structural particles have a size between minus 40 mesh and plus 300 mesh.

18. The method of claim 1, wherein the mixing step comprises using a paddle mixer, a ribbon blender or mixer, a V blender, a continuous processor, a cone screw blender, a counter-rotating mixer, a double & triple shaft mixer, drum blenders, an intermix mixer, a horizontal mixer, or a vertical mixer.

19. The method of claim 5, wherein the mixing step comprises using belts, augers, metered feeding, pneumatic feeding, or a loss in weight feeder.

20. The method of claim 5, further comprising a second mixing step wherein the engineered asphalt additive is mixed using aggregate feed belts, a RAP collar, or pug mill.
